(19) United States
(12) Patent Application Publication
(10) Pub. No.: US 2025/0390748 A1
(43) Pub. Date: Dec. 25, 2025

(54) MECHANISMS FOR IMPLEMENTING VIRTUAL LINKING NODES FOR GRAPH NEURAL NETWORKS

(71) Applicant: PayPal, Inc., San Jose, CA (US)

(72) Inventors: Ori Mendelson, Tel-Aviv (IL); Ofek Levy, Tel-Aviv (IL)

(21) Appl. No.: 18/753,053

(22) Filed: Jun. 25, 2024

(51) Int. Cl. G06N 3/082

(52) U.S. Cl. CPC G06N 3/082

(57) ABSTRACT

Techniques are disclosed pertaining to classifying an event. A computer system may receive event information identifying event features of the event. The computer accesses a graph neural network model trained based on modified graph data describing a graph data structure having a plurality of event nodes representing events and a plurality of feature nodes representing combinations of event features. The graph data structure includes a virtual linking node that links a first node group to a second node group to enable a first set of event nodes of the first group to influence a second set of event nodes of the second group during a training phase in which the graph neural network model is trained based on the modified graph data. The computer system generates an event node representation of the event and then classifies the event based on the event node representation and the graph neural network model.

### BACKGROUND

### Technical Field

This disclosure relates generally to computer systems and, more specifically, to various mechanisms pertaining to graph neural networks for node classification.

### Description of the Related Art

Enterprises are increasingly utilizing machine learning to enhance the services that they provide to their users. Using machine learning techniques, a computer system can train models from existing data and then use them to identify similar trends in new data. In some cases, the training process is supervised in which the computer system is provided with labeled data that it can use to train a model. For example, a model for identifying spam can be trained based on emails that are labeled as either spam or not spam. Examples of supervised learning algorithms include linear regression, logistic regression, and support vector machines. In other cases, the training process can be unsupervised in which the computer system is provided with unlabeled data that it can use to train a model to discover underlying patterns in that data. Unsupervised training may be favored in scenarios in which obtaining labeled data is difficult, costly, and/or time-consuming.

### BRIEF DESCRIPTION OF THE DRAWINGS

FIG. 1 is a block diagram of one embodiment of a classification system that is capable of classifying new node data using a trained machine learning model.

FIG. 2A is a block diagram of one embodiment of different node groups having nodes that are interconnected by edges as described by graph data.

FIG. 2B is a block diagram of one embodiment of an insertion of virtual linking nodes and edges to link a set of separate nodes to generate enhanced graph data.

FIG. 3 is a block diagram of one embodiment of message passing steps performed as a part of training a machine learning model based on enhanced graph data.

FIG. 4A is a block diagram of one embodiment of training a set of weights of a machine learning model in accordance with a set of weight rules.

FIG. 4B is a block diagram of another embodiment of training a set of weights of a machine learning model in accordance with a set of weight rules.

FIG. 5 is a block diagram of one embodiment of generating a classification of a new node using a trained machine learning model.

FIG. 6 is a flow diagram illustrating one embodiment of a method for classifying an event based on an event node representation and a graph neural network model.

FIG. 7 is a flow diagram illustrating one embodiment of a method for training a machine learning model based on a modified graph data set.

FIG. 8 is a flow diagram illustrating one embodiment of a method for classifying an event based on an event node representation and a trained graph neural network model.

FIG. 9 is a block diagram illustrating elements of a computer system for implementing various systems described in the present disclosure, according to some embodiments.

### DETAILED DESCRIPTION

Graph data structures are often used to represent entities and the relationships between those entities. For example, a graph data structure may be a social network graph where nodes represent users, and edges denote friendships or interactions between the users. In some cases, certain entities can share a set of features/attributes while other entities share a different set of features. For example, a user account can be associated with an Internet Protocol (IP) address, a city, and a phone number while a different user account is associated with the city and the IP address but an e-mail address instead of the phone number. One type of graph data structure that can be used to represent the user accounts and features is a bipartite graph in which there are two sets of nodes (e.g., user account nodes and features nodes) and edges between those two sets but not within them. As an example, user accounts that share the same number and types of features (e.g., the same IP address, city, and phone number) can be represented as user account nodes connected to a features node representing the combination of the features.

It is often desirable to analyze graph data structures to discover features of the data or make predictions on whether nodes within the graph data structures are associated with certain properties. One approach to analyzing graph data structures is to utilize a graph neural network (GNN) model that is a class of machine learning model designed to operate on graph-structured data. During training and inference phases, a GNN model can aggregate information from the neighboring nodes of a given node and use that information to update a node representation of the given node. Accordingly, a GNN model's ability to assess a node can be dependent on the number of neighboring nodes to that particular node. As mentioned, certain entities can share the same features while other entities share the same but also different features. In many cases, the entities can overlap on their features except for one or two features (e.g., the phone number versus the e-mail address) and thus the entities are often very similar to each other. But despite these entities sharing similar features, they can be located in different locations within a graph data structure. As a result, when analyzing these entities and their relationships, they may not influence each other as a part of the GNN model aggregating information from neighboring nodes within the graph data structure. This setup can create a challenging problem for standard GNN architectures to solve since naturally some of the nodes may be isolated and thus do not receive much information from neighboring nodes. Accordingly, this disclosure addresses, among other things, the problem of how to enable a machine learning model to be able to assess similar nodes in view of each other when those nodes are located in separate parts of a graph data structure and make improved predictions/classifications on nodes that are isolated (have relatively few neighboring nodes).

The present disclosure describes embodiments in which a classification system adds virtual linking nodes to a graph data structure to cause a graph neural network to consider interrelationships that are not readily apparent. As will be described in various embodiments, a computer system attempting to classify an event can access a graph neural network model trained based on modified graph data that describes a graph data structure having a plurality of event nodes representing events and a plurality of feature nodes representing combinations of event features. The graph data structure may include a first group of nodes having a first set of event nodes connected to a first feature node and a second group of nodes having a second set of event nodes connected to a second feature node. To cause the graph neural network to consider a relationship between these two groups, which it might not otherwise consider, the first group is connected to the second group via a virtual linking node that enables the first set of event nodes to influence the second set of event nodes during a training phase in which the graph neural network model is trained based on the modified graph data.

When the computer system later attempts to classify a new event, the computer system receives event information identifying event features of the event and generates an event node representation associated with the event based on the event features of the event. Those event features can correspond to a combination of event features represented by the second feature node, for example. The computer system then classifies the event based on the event node representation and the graph neural network model that was trained on the graph data structure having virtual nodes. These techniques may be advantageous over prior approaches as these techniques utilize a virtual linking node to connect a set of nodes such that these nodes share information with each other during the training and inference phases of a machine learning model. That is, by using virtual linking nodes to link nodes that may share similar features and be located in separate parts of a graph data structure, those nodes can influence each other such that the classification of a given one of the nodes may be improved relative to when the nodes are not linked via a virtual node. Accordingly, this approach improves graph neural networks (e.g., their ability to make predictions/classifications) and thus represents an improvement in the field of machine learning technology.

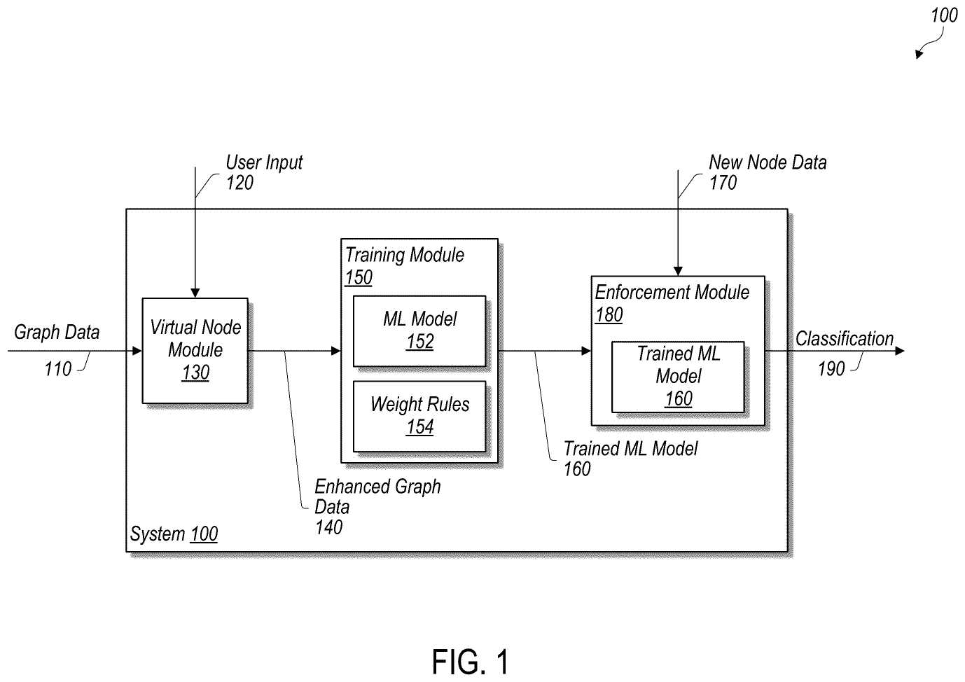

Turning now to FIG. 1, a block diagram of system 100 is shown. System 100 includes a set of components that may be implemented via hardware or a combination of hardware and software routines. In the illustrated embodiment, system 100 includes a virtual node module 130, a training module 150, and an enforcement module 180. Also as shown, training module 150 includes a machine learning (ML) model 152 and weight rules 154. As further shown, enforcement module 180 includes a trained ML model 160. In some embodiments, system 100 is implemented differently than shown. For example, enforcement module 180 may provide trained ML model 160 with new node data 170 to training module 150 so that it can be trained in view of new node data 170. Further, while training module 150 and enforcement module 180 are shown as part of the same system, in some embodiments, they can be part of different systems and thus the training and inference/enforcement phases for a ML model can occur in different locations.

System 100, in various embodiments, is a platform that provides one or more services (e.g., a cloud computing service, a customer relationship management service, and a payment processing service) that are accessible to users that can invoke functionality of the services to achieve a user-desired objective. To facilitate the functionality of those services, system 100 may execute various software routines, such as enforcement module 180, as well as provide code, web pages, and other data to users, databases, and other entities that use system 100. In various embodiments, system 100 is implemented using a cloud infrastructure that is provided by a cloud provider. Components of system 100 may thus execute on and use cloud resources of that cloud infrastructure (e.g., computing resources, storage resources, etc.) to facilitate their operation. For example, software that is executable to implement virtual node module 130 may be stored on a non-transitory computer-readable medium of server-based hardware included in a datacenter of the cloud provider. That software may be executed in a virtual environment that is hosted on the server-based hardware. In some embodiments, system 100 is implemented using a local or private infrastructure as opposed to a public cloud.

In various embodiments, system 100 trains ML model 152 based on enhanced graph data 140 to produce trained ML model 160 and then uses trained ML model 160 to generate a classification 190 (e.g., fraudulent or not fraudulent) for a node (e.g., a node representing an event or user) based on new node data 170. An event may be of any type of event facilitated by computer systems—examples of different types of events include, but are not limited to, database transactions, payment transactions, authentication/verification operations, account sign-ups, network routing operations (e.g., downloads). Different instances of an event type can be associated with different event features. As an example, an account sign-up event may be associated with a first country while another account sign-up event is associated with a second country. Furthermore, different event types can be associated with different types of event features. For example, a database transaction may be associated with a central processing unit (CPU) usage feature describing an amount of CPU resources used to process the database transaction while an account sign-up event may not be associated with the CPU usage feature. To facilitate the generation of classification 190, system 100 can receive graph data 110, as shown in the illustrated embodiment.

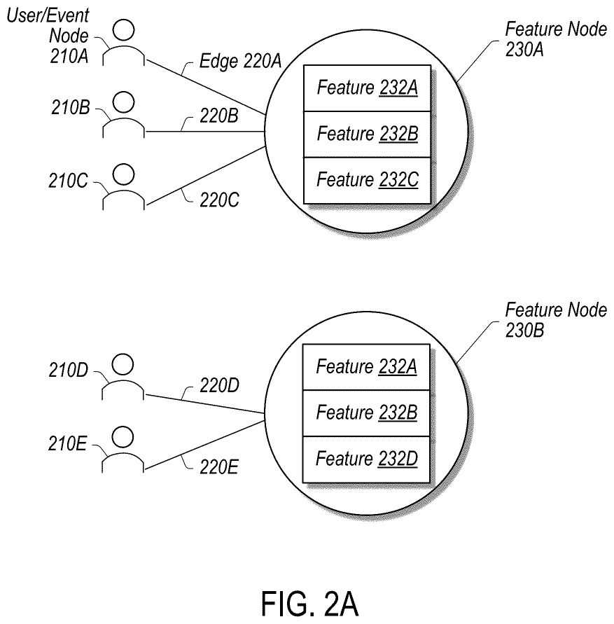

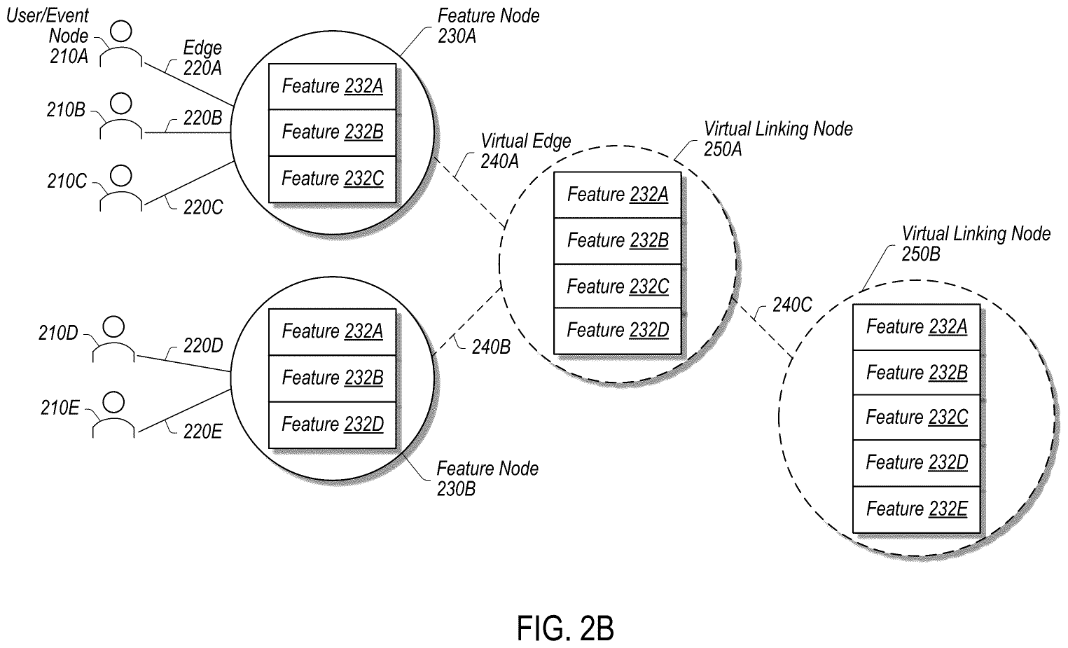

Graph data 110, in various embodiments, is information that describes a graph data structure that includes nodes interconnected by edges. The graph data structure may be a bipartite graph having two sets of nodes with edges between those sets. For example, graph data 110 may describe a bipartite graph having user/event nodes that are connected to feature nodes representing different combinations of features. To facilitate training and inference using an ML model, a node may be represented as a vector (e.g., an embedding) that describes one or more features, which may be associated with a user and/or an event corresponding to that node. For example, the embedding of a particular user/event node may represent the IP address, the city, and the e-mail address of a user associated with an event. Graph data 110 is discussed in greater detail with respect to FIG. 2A. As depicted, graph data 110 is provided to virtual node module 130.

Virtual node module 130, in various embodiments, is software that is executable to insert one or more virtual linking nodes and edges into the graph data structure described by graph data 110 to link unconnected nodes, resulting in enhanced graph data 140. For example, virtual node module 130 may determine to insert a virtual linking node to link two or more nodes that share over a threshold number of the same features. By linking those nodes through the virtual linking node, the nodes may influence each other (during the training of ML model 152 and its subsequent use to generate classification 190) as information can pass between the nodes via the linking node during message passing steps. The determination to insert a virtual linking node may be based on received user input 120—e.g., a user may identify where to insert a virtual linking node based on their domain knowledge. User input 120 is discussed in greater detail with respect to FIG. 2A and virtual node module 130 is discussed in greater detail with respect to FIG. 2B. As depicted, enhanced graph data 140 is provided to training module 150.

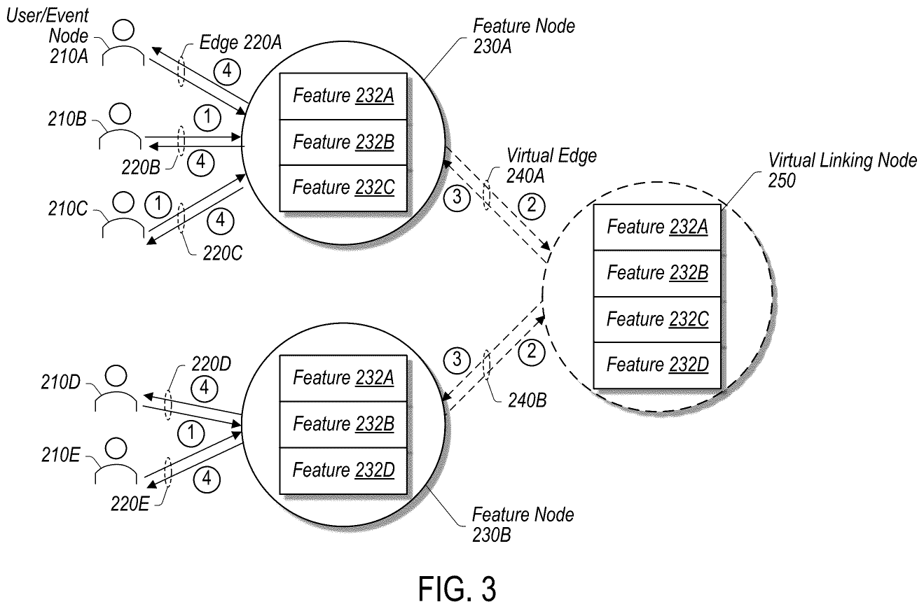

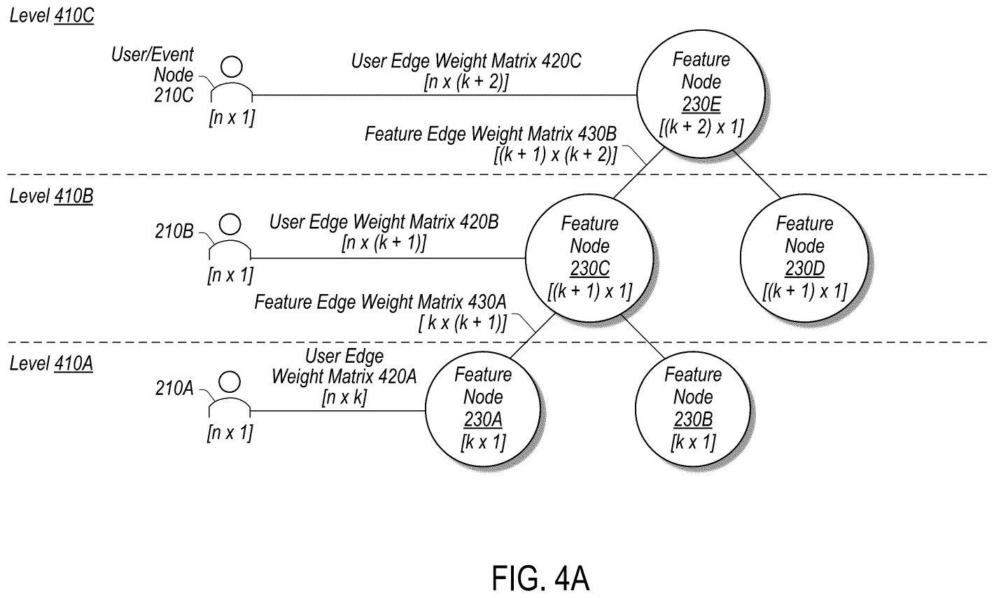

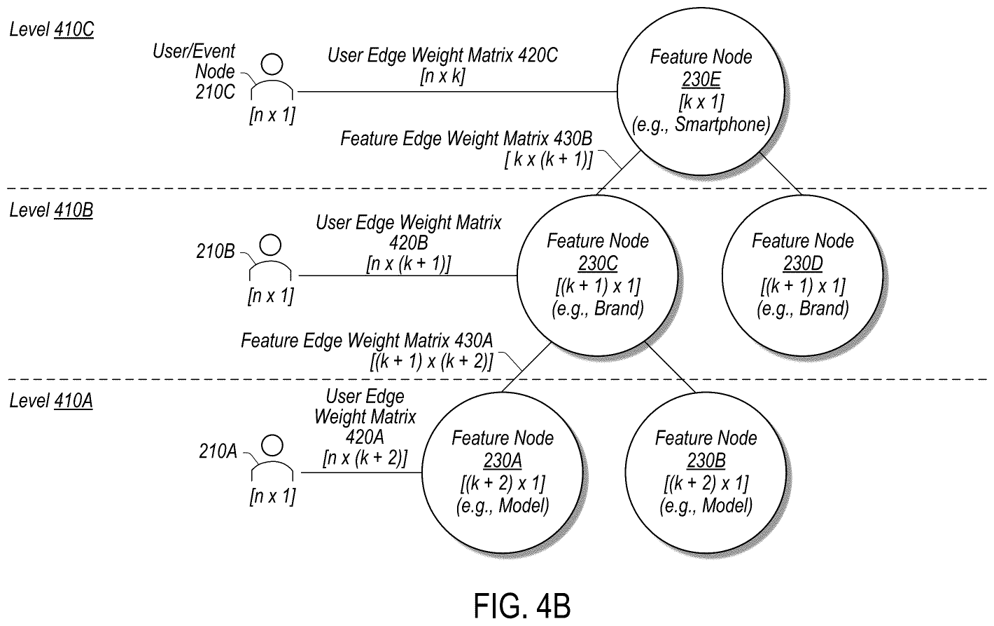

Training module 150, in various embodiments, is software that is executable to train ML model 152 based on enhanced graph data 140. ML model 152, in various embodiments, uses one or more neural networks (e.g., graph neural networks) to process enhanced graph data 140. Training module 150 may implement a training process that involves a loss function and backpropagation to update weights (e.g., the weights of the neural networks) that are used by ML model 152, resulting in trained ML model 160. Training module 150 may train ML model 152 in accordance with a set of weight rules 154. Weight rules 154, in various embodiments, are constraints placed on how weight matrices are derived during the training of ML model 152. Weight rules 154 may be implemented to reduce the number of trainable parameters and therefore reduce the overall computation cost and time involved in training ML model 152. Training module 150 is discussed in greater detail with respect to FIG. 3, and weight rules 154 are discussed in greater detail with respect to FIG. 4A. As depicted, trained ML model 160 is provided to enforcement module 180.

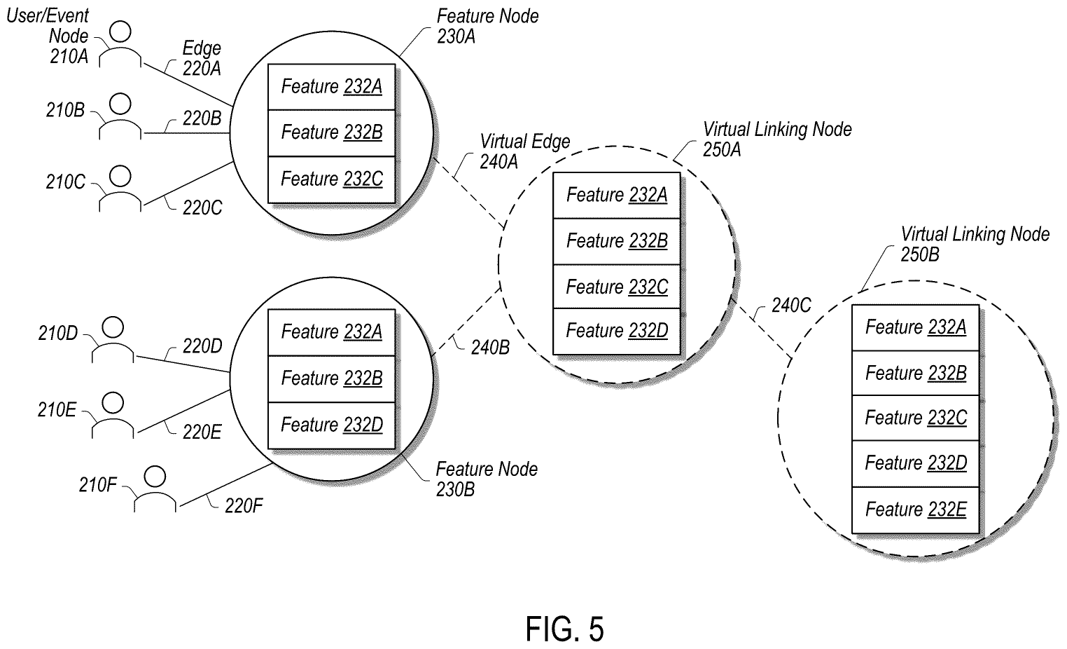

Enforcement module 180, in various embodiments, is software executable to generate classification 190 for new node data 170 using trained ML model 160. New node data 170, in various embodiments, is information that describes one or more features associated with a new user and/or event. Enforcement module 180 may generate a node representation (e.g., a vector embedding) for the new user and/or event based on new node data 170 and then insert it into enhanced graph data 140. Enforcement module 180, in various embodiments, uses trained ML model 160 to process enhanced graph data 140, including the inserted node representation, to generate classification 190. In various cases, trained ML model 160 may generate an updated node representation (e.g., an updated embedding) that is then classified by enforcement module 180 using a classification model to generate classification 190. Classification 190, in various embodiments, is a label that describes the user and/or event associated with new node data 170. For example, classification 190 might indicate that the user associated with the new node is a licit user. Enforcement module 180 is described in greater detail with respect to FIG. 5.

Turning now to FIG. 2A, a block diagram of an example portion of a graph data structure described by graph data 110 is shown. In the illustrated embodiment, the graph data structure includes user/event nodes 210A-E, edges 220A-E, and feature nodes 230A-B. Also as shown, feature node 230A includes features 232A, 232B, and 232C, and feature node 230B includes features 232A, 232B, and 232D. In some embodiments, the graph data structured described by graph data 110 is implemented differently than shown. For example, the graph data structure may include a greater number of feature nodes 230 with fewer or greater number of features 232 and/or the graph data structure may not be a bipartite graph. Also, while user/event nodes 210 are described throughout this disclosure, other types of nodes may be used. For example, nodes representing computer systems may be connected to feature nodes representing features of those computer systems.

The illustrated embodiment depicts a bipartite graph structure having feature nodes 230 and user/event nodes 210 interconnected by edges 220. A user/event node 210, in various embodiments, corresponds to a user or an event and is represented as a vector embedding that encapsulates one or more features 232 associated with the user and/or the event. A feature 232, in various embodiments, is a property or characteristic that can describe a user and/or event, such as a geographic location (e.g., country), a behavioral property, a computing device property (e.g., the type of device, such as a desktop), a network property (e.g., an IP address), etc. As an example, a user/event node 210 may be associated with features 232 that represent the model of a device, the operating system of the device, a web browser, a geographical location, typing patterns, and an IP address, all of which might be collected from a user during an event, such as an account signup.

Separate instances of a particular type of event may exhibit a set of shared features 232. For example, a shared set of features 232 may be collected during separate signup events, such as a city, an e-mail domain, and a phone number prefix. User/event nodes 210 that share the features 232 may be connected to a feature node 230 via edges 220. A feature node 230, in various embodiments, is represented as a vector embedding that corresponds to the shared features of one or more user/event nodes 210. In the illustrated embodiment, user/event nodes 210A-C share features 232A-C and thus are connected to feature node 230A via edges 220A-C, respectively. For example, user/event nodes 210A-C may be associated with the same email address, the same phone number, and the same IP address. In some cases, user/event nodes 210 may be associated with different values that satisfy the same feature 232. As an example, user/event nodes 210A-C may be associated with different phone numbers, but those phone numbers may have the same phone number prefix and thus user/event nodes 210A-C may be associated with the same feature 232 (the phone number prefix in this example.) User/event nodes 210D and 210E share features 232A, 232B, and 232D and are connected to feature node 230B via edges 220D and 220E, respectively. Thus, for example, user/event nodes 210D and 210E may be associated with the same email address and phone number as user/event nodes 210A-C but not the same IP address. While nodes 210A-C may share many features 232 with nodes 210D and 210E, in various cases, nodes 210D and 210E may be located in a different part of the bipartite graph than nodes 210A-C. Accordingly, when training ML model 152 on the illustrated graph data structure that does not include virtual linking nodes, nodes 210A-C may not influence nodes 210D and 210E (or vice versa) during a message passing phase since messages from nodes 210A-C may not reach nodes 210D and 210E.

Turning now to FIG. 2B, a block diagram of an example insertion of virtual linking nodes 250 into a graph data structure to generate enhanced graph data 140 is shown. In the illustrated embodiment, the graph data structure includes user/event nodes 210A-E, edges 220A-E, feature nodes 230A-B, virtual edges 240A-C, and virtual linking nodes 250A-B. As further depicted, feature node 230A includes features 232A-C, and feature node 230B includes features 232A, 232B, and 232D. Also as depicted, virtual linking node 250A includes features 232A-D, and virtual linking node 250B includes features 232A-E. In some embodiments, the graph data structure described by enhanced graph data 140 is implemented differently than shown. For example, the graph data structure may include a fewer and/or greater number of user/event nodes 210, feature nodes 230, and/or virtual linking nodes 250.

As discussed, in various embodiments, virtual node module 130 is software executable to insert one or more virtual linking nodes 250 and virtual edges 240 to link feature nodes 230 that share a subset of features 232. A virtual linking node 250, in various embodiments, is represented as a vector embedding that corresponds to a combination of all the features 232 of the two or more feature nodes 230 connected to it via virtual edges 240. In the illustrated embodiment, because feature node 230A and feature node 230B share a subset of features (e.g., features 232A and 232B), virtual node module 130 inserts a virtual linking node 250A to connect feature node 230A to feature node 230B. For example, feature node 230A may represent a particular city, IP address, and e-mail address, and feature node 230B may represent the same city, the same IP address, and a phone number. Because feature nodes 230A and 230B represent the same city and IP address, virtual node module 130 inserts a virtual linking node 250A and virtual edges 240A and 240B to link nodes 230A and 230B. Accordingly, virtual linking node 250A represents the city, the IP address, the e-mail address, and the phone number of feature nodes 230A and 230B. But in some embodiments, virtual linking nodes 250 correspond to only the features 232 that are the same between the two or more feature nodes 230 being linked. Accordingly, virtual linking node 250A may represent only the city and the IP address of feature nodes 230A and 230B in the above example.

In some embodiments, the determination to insert a virtual linking node 250 is based on user input 120. User input 120, in various embodiments, includes parameters provided by a user for linking two or more feature nodes 230. For example, virtual node module 130 may insert a virtual linking node 250 to link feature nodes 230 that share a specific combination of features 232 based on user input 120. In some embodiments, user input 120 may specify a minimum number of shared features 232 required to link two or more feature nodes 230. For example, virtual node module 130 may insert a virtual linking node 250 if two or more feature nodes 230 share at least four or more features 232. In some embodiments, user input 120 provides the links and locations of a virtual linking node 250 to virtual node module 130. For example, user input 120 may specifically instruct virtual node module 130 to link feature node 230A and 230B by inserting virtual linking node 250A.

In some embodiments, enhanced graph data 140 describes a hierarchical graph structure in which the user/event nodes 210, feature nodes 230, and virtual linking nodes 250 are located on different levels of the hierarchical graph. For example, a child feature node 230 may be located on a lower level of the hierarchical graph structure and linked to a parent virtual linking node 250 located on a higher level via a virtual edge 240. In some embodiments, features nodes 230 located on separate lower levels of the hierarchical graph structure may be linked to a virtual linking node 250 located on a third level. Levels are discussed in greater detail with respect to FIG. 4. After inserting virtual linking nodes 250 into graph data 110 to generate enhanced graph data 140, virtual node module 130 may provide enhanced graph data 140 to training module 150.

Turning now to FIG. 3, a block diagram of an example of a message passing operation performed as a part of training ML model 152 based on enhanced graph data 140 is shown. In the illustrated embodiment, the message passing operation involves user/event nodes 210A-E, edges 220A-E, feature nodes 230A-B, virtual edges 240A-C, and a virtual linking node 250. As further depicted, feature node 230A includes features 232A, 232B, and 232C, and feature node 230B includes features 232A, 232B, and 232D. Also as depicted, virtual linking node 250 includes features 232A-D. In some embodiments, the message passing operation may be implemented differently than shown.

As discussed, training module 150 can train ML model 152 based on enhanced graph data 140 and weight rules 154. ML model 152, in various embodiments, uses one or more neural networks (e.g., graph neural network) to process enhanced graph data 140 and update the embeddings for one or more user/event nodes 210, feature nodes 230, and/or virtual linking nodes 250 In some embodiments, enhanced graph data 140 is provided to a preprocessing engine to produce an initial set of embeddings, using feature extraction techniques, for user/event nodes 210, feature nodes 230, and virtual linking node 250. In order to update the embedding of a user/event node 210, training module 150 performs a set of message passing operations as part of a message passing phase.

A message passing operation, in various embodiments, involves passing “messages” containing information (e.g., embeddings) along the edges of a graph data structure in order to aggregate, using an aggregation function (e.g., sum, mean, etc.), the embeddings of neighboring nodes with the embedding of a target node. A target node may be one or more user/event nodes 210, feature nodes 230, and/or virtual linking nodes 250. For example, the embedding of a user/event node 210 may be passed as a message and aggregated with the embedding of a target feature node 230. The target node may be determined based on its location in a hierarchical graph structure. For example, nodes located on the first level of a hierarchical graph may pass their messages to nodes located on a second level.

In the illustrated embodiment, at step 1, the embeddings of user/event nodes 210A-C are passed as messages along edges 220A-C, respectively, and aggregated with the initial embedding of feature node 230A. For example, the embeddings of user/event node 210A-C may be passed along edges 220A-C and summed with the embedding of feature node 230A. At step 1, the embeddings of user/event nodes 210D and 210E are passed along edges 220D and 220E and aggregated with the initial embedding of feature node 230B. In some embodiments, the embedding of a user/event node 210 is transformed by applying a weight matrix, resulting in a weighted embedding, prior to aggregating its embedding (the weighted version) with the embedding of feature node 230. The weight matrix may represent the weight of an edge 220 or a virtual edge 240.

The values of the weight matrix may be initialized randomly and updated through the training process, using a loss function (e.g., cross-entropy loss) and backpropagation. Training module 150, in various embodiments, computes a value by comparing a predicted label to the correct label for one or more nodes in the graph data structured described by enhanced graph data 140. For example, ML model 152 may initially classify a particular user/event node 210 as fraud. The fraud classification is compared to the correct classification of the user/event node 210 in order to compute a score that represents the prediction error. Based on the loss score, ML model 152 may update each weight using backpropagation to minimize prediction error. In some embodiments, the weight matrix is determined based on training and a set of weight rules 154. Weight rules 154 are discussed in greater detail with respect to FIG. 4.

After aggregating the embeddings of user/event nodes 210A-E to their respective target feature nodes 230A and 23B, ML model 152 may use a neural network to introduce non-linear transformations to the aggregated embeddings for each target feature node 230, using an activation function such as Rectified Linear Unit (ReLU). An activation function determines if the node in the neural network is activated based on an activation value. For example, the node of a neural network may activate if the activation value from the activation function is a positive value. Otherwise, the node of the neural network with a negative value will not activate and thus will not produce an output. By introducing non-linear transformations, ML model 152 may identify non-linear relationships in the graph data structure described by enhanced graph data 140. A non-linear transformation may be applied at each message passing step, resulting in an updated representation for the target node. After the representations for one or more target nodes are updated, those nodes may pass their updated representations as messages to another set of one or more target nodes as part of a new message passing step.

In the illustrated embodiment, machine learning model 152 performs a second message passing operation. At step 2, feature nodes 230A and 230B pass their updated embeddings (from the message passing operation at step 1) to virtual linking node 250, via virtual edges 240A and 240B, to update its representation. The message passing operation at step 2 may include the same or similar actions as the message passing operation of step 1 in order to update the embedding for virtual linking node 250.

In the illustrated embodiment, machine learning model 152 performs a third message passing operation. At step 3, virtual linking node 250 passes its updated representation (from step 2) to feature nodes 230A and 230B via virtual edges 240A and 240B, respectively. The message passing operation of step 3 may include the same or similar actions as the message passing operation of step 1 in order to update the embeddings of feature nodes 230A and 230B.

In the illustrated embodiment, machine learning model 152 performs a fourth message passing operation. At step 4, feature node 230A passes its updated embedding (from step 3) to user nodes 210A-C in order to update their respective representations. Feature node 230B passes its updated embedding (from step 3) to user nodes 210D-E in order to update their respective representations. The message passing operation at step 4 may include the same or similar set of steps as the message passing operation at step 1, resulting in updated embeddings for each user/event node 210. In some embodiments, messages are passed upstream and downstream, including being aggregated at the various nodes in the traversal path of steps 1-4, prior to undergoing a non-linear transformation. Since user/event nodes 210A-C are coupled to user nodes 210D and 210E via virtual linking node 250, messages from both groups of nodes are able to reach the other group and influence their embeddings—e.g., user/event node 210A's embedding is able to influence the embedding of user/event node 210D.

Turning now to FIG. 4A, a block diagram of example weight matrices of a ML model 142 trained in accordance with weight rules 154 is shown. In the illustrated embodiment, there are user edge weight matrices 402A-C and feature edge weight matrices 430A and 430B that are located on levels 410A-C. In some embodiments, user edge weight matrices 402A-C and feature edge weight matrices 430A and 430B are implemented differently than shown—e.g., user edge weight matrices 402A-C may not be set based on each other.

Weight rules 154, in various embodiments, are rules that constrain how training module 150 derives weight matrices. In particular, weight matrices of higher levels 410 may be derived from weight matrices located on lower levels 410 of the hierarchical graph structure. In the illustrated embodiment, user/event node 210A is located on level 410A and is associated with an [n×1] embedding that represents the context (e.g., features 232) associated with level 410A. For example, the [n×1] embedding may represent an IP address, a phone number, and a city. User/event nodes 210A-C may be associated with embeddings of the same size but provide different amounts of information in the creation of their respective embeddings. For example, user/event node 210A's embedding may be generated based on an IP address, a phone number, and a city while user/event node 210B's embedding is generated based on the same IP address, phone number, and city but also a device identifier. User/event node 210A's embedding may include a null or default value for the device identifier when it is not associated with a device identifier. User/event node 210A is linked to feature node 230A via an edge. In the illustrated embodiment, the edge is associated with user edge weight matrix 420A that is a [n×k] matrix, where “k” can represent the hierarchy level 410 or the number of features 232 of the feature node 230 associated with the edge. As discussed, in various embodiments, the weights of ML model 152 are updated using backpropagation. Accordingly, the weights of user edge weight matrix 420A may be continually adjusted as ML model 152 is trained.

In the illustrated embodiment, user/event node 210B is located on a higher level 410B and includes an [n×1] embedding that represents the context (e.g., features 232) associated with level 410B. For example, user/event node 210A located on level 410A may introduce a first feature 232, such as an IP address, and user/event node 210B located on level 410B may introduce an additional, second feature 232, such as the model of a device. Consequently, the embedding of user/event node 210B may include more context (a representation of the model of the device) than the embedding of user/event node 210A. Each level 410 of the hierarchical graph, in various embodiments, includes an additional feature 232 such that the highest level 410C includes the greatest number of features 232. User/event node 210B is linked to feature node 230C via an edge. In the illustrated embodiment, that edge is associated with user edge weight matrix 420B that is a [n×(k+1)] matrix. In various embodiments, user edge weight matrix 420B includes a set of additional weights (e.g., a weight vector) that corresponds to the additional feature(s) 232 associated with feature node 230C. The other weights of weight matrix 420B may correspond to the same features 232 shared between feature nodes 230A and 230C. Accordingly, to reduce the number of trainable parameters, in various embodiments, weight rules 154 cause training module 150 to set these other weights to the same value as the weights in weight matrix 420A—i.e., the [n×k] portion of weight matrix 420B may equal the corresponding weights of weight matrix 420A. Because ML model 152 may only train for the additional content at each level 410, the number of trainable parameters may be reduced by a factor of [n×k] for each hierarchy level. Consequently, the amount of compute resources and time that is spent training ML model 152 is reduced, representing another improvement to the field of machine learning technology.

As further shown, feature node 230A is linked to feature node 230C, which is located on a higher level of the hierarchical graph structure, via a feature edge (e.g., an edge 220 or 240). In the illustrated embodiment, that edge is associated with feature edge weight matrix 430A that is a [k×(k+1)] matrix. To reduce the number of trainable parameters, in various embodiments, weight rules 154 cause training module 150 to set the weights of feature edge weight matrix 430A such that the dot product of user edge weight matrix 420A and feature edge weight matrix 430A equals user edge weight matrix 420B. Because feature node 230A and 230B are linked to feature node 230C, the feature edge weight matrix 430 for the edge linking feature node 230B to feature node 230C may be equivalent to feature edge weight matrix 430A. In the illustrated embodiment, feature node 230C is linked to feature node 230E, located on a higher level of the hierarchical graph structure, via a feature edge associated with feature edge weight matrix 430B that is a [(k+1)×(k+2)] matrix. Feature edge weight matrix 430B may also be set such that the dot product of user edge weight matrix 420B and feature edge weight matrix 430B equals user edge weight matrix 420C.

In the illustrated embodiment, user/event node 210C is located on the highest level 410C and includes an [n×1] embedding that represents the context (e.g., features 232) associated with level 410C. In various embodiments, user edge weight matrix 420C is derived in part from user edge weight matrix 420B while the additional weights of weight matrix 420C (that correspond to the additional features 232 of feature node 230E over feature node 230C) are trained, e.g., using back propagation. Because weight rules 154 introduces a weight sharing mechanism, the number of trainable parameters is reduced.

Turning now to FIG. 4B, a block diagram of a second example of weights of a ML model 142 trained in accordance with weight rules 154 is shown. In the illustrated embodiment, there are user edge weight matrices 420A-C and feature edge weight matrices 430A and 430B located on levels 410A-C. In some embodiments, user edge weight matrices 420A-C and feature edge weight matrices 430A and 430B are implemented differently than shown. For example, user edge weight matrices 420A-C may not be set based on each other.

In contrast to FIG. 4A, each lower level 410 of the hierarchical graph in FIG. 4B includes one or more additional features 232 than the higher level 410 such that the lowest level 410A includes the greatest number of features 232. Accordingly, weight matrices of lower levels 410 may be derived from weight matrices located on higher levels 410 of the hierarchical graph. In the illustrated embodiment, level 410C includes a feature node 230E that represents a broad category, such as electronics or smartphones. Level 410B includes feature nodes 230C and 230D that represent additional context associated with the category, such as a brand associated with the smartphone. Level 410A includes feature nodes 230A and 230B that represent further additional context, such as the model associated with the brand.

In the illustrated embodiment, user/event node 210C is located on level 410C and is associated with an [n×1] embedding that represents the context (e.g., features 232) associated with level 410C. User/event nodes 210A-C may be associated with embeddings of the same size but provide different amounts of information in the creation of their embeddings. For example, user/event node 210C's embedding may be generated based on a smartphone device category while user/event node 210B's embedding is generated based on the smartphone device category in addition to a particular device brand. User/event node 210C's embedding may include a null or default value for the device brand feature when it is not associated with a device brand. User/event node 210C is linked to feature node 230E via an edge associated with user edge weight matrix 420C that is a [n×k] matrix, where “k” can represent the hierarchy level 410 or the number of features 232 of the feature nodes 230 associated with the edge. As discussed, in various embodiments, the weights of ML model 152 are updated using backpropagation. Accordingly, the weights of weight matrix 420A may be continually adjusted as ML model 152 is trained.

In the illustrated embodiment, user/event node 210B is located on a lower level 410B and includes an [n×1] embedding that represents the context (e.g., features 232) associated with level 410B. For example, user/event node 210C located on level 410C may introduce a first feature 232, such as a smartphone, and user/event node 210B located on level 410B may introduce an additional, second feature 232, such as a particular brand of smartphone. As such, the embedding of user/event node 210B may include more context (a representation of the brand) than the embedding of user/event node 210C. User/event node 210B is linked to feature node 230C via an edge associated with user edge weight matrix 420B that is a [n×(k+1)] matrix. In various embodiments, user edge weight matrix 420B includes a set of additional weights that correspond to the additional feature(s) 232 associated with feature node 230C that are not associated with feature node 230E. The other weights of weight matrix 420B may correspond to the same features 232 shared between feature nodes 230A and 230C. To reduce the number of trainable parameters, in various embodiments, weight rules 154 cause training module 150 to set these other weights to the same value as the weights in weight matrix 420C—i.e., the [n×k] portion of weight matrix 420B may equal the corresponding weights of weight matrix 420C. Since machine learning model 152 only trains for the additional content at each level 410, the number of trainable parameters can be reduced by a factor of [n×k] for each hierarchy level.

As further shown, feature node 230E is linked to feature node 230C, which is located on a lower level of the hierarchical graph structure, via a feature edge (e.g., an edge 220) that is associated with feature edge weight matrix 430B that is a [k×(k+1)] matrix. To reduce the number of trainable parameters, in various embodiments, weight rules 154 cause training module 150 to set the weights of feature edge weight matrix 430B such that the feature edge weight matrix is derived after the user edge weights have been determined and is such that the dot product of user edge weight matrix 420C and feature edge weight matrix 430B equals user edge weight matrix 420B. Because feature node 230C and 230D are linked to feature node 230E, the feature edge weight matrix 430 for the edge linking feature node 230E to feature node 230D may be equivalent to feature edge weight matrix 430B. In the illustrated embodiment, feature node 230C is linked to feature node 230A, located on a lower level of the hierarchical graph structure, via a feature edge associated with feature edge weight matrix 430A that is a [(k+1)×(k+2)] matrix. Feature edge weight matrix 430A may also be set such that the dot product of user edge weight matrix 420B and feature edge weight matrix 430A equals user edge weight matrix 420A.

In the illustrated embodiment, user/event node 210A is located on the lowest level 410A and includes an [n×1] embedding that represents the context (e.g., features 232) that is associated with level 410A. In various embodiments, user edge weight matrix 420A is derived in part from user edge weight matrix 420B while the additional weights of weight matrix 420A (that correspond to the additional features 232 of feature node 230A over feature node 230B) are trained, e.g., using back propagation. Because weight rules 154 introduces a weight sharing mechanism, the number of trainable parameters is reduced.

Turning now to FIG. 5, a block diagram illustrating an example of classifying new node data 170 based on trained ML model 160 is shown. In the illustrated embodiment, the graph data structure is similar to the graph data structure of FIG. 2B except new node data 170 is represented as an user/event node 210F and is linked to feature node 230B. In some embodiments, new node data 170 is implemented differently than shown. For example, new node data 170 may be linked as a user/event node 210 to virtual linking node 250A.

As part of classifying a user/event node 210, enforcement module 180 receives new node data 170 associated with an event. New node data 170, in various embodiments, is data collected during the event that identifies one or more features 232. New node data 170 may be received from a user session initiated via a user interface (e.g., a web browser), a database, a separate computer system, etc. Based on the new node data 170, enforcement module 180 generates a user/event node 210 with an initial vector representation (embedding) and inserts it into enhanced graph data 140. In some embodiments, that user/event node 210 is provided to enforcement module 180. For example, enforcement module 180 may receive user/event node 210F from a separate module that generates the initial embedding for new node data 170. Enforcement module 180 may determine its position in the graph data structure based on its features 232 and/or user input 120. For example, enforcement module 180 may determine to link the new user/event node 210 to a particular feature node 230 based on its features 232 satisfying a similarity threshold or matching the features of that feature node 230.

In the illustrated embodiment, user/event node 210F is linked to feature node 230B via edge 220F. Because user/event node 210F is connected to feature node 230B, edge 220F can inherit the user edge weight matrix 420 (generated through the training process) from the edges 220 connecting its neighboring user/event nodes 210E and 210D to feature node 230B. For example, edges 220D and 220E may include a user edge weight matrix 420 of [n×k] and thus the user edge weight matrix 420 of edge 220F is set to represent the same [n×k] matrix.

After user/event node 210F is inserted and its respective weights are set, enforcement module applies trained ML model 160 to classify user/event node 210F based on the labels of neighboring nodes. Trained ML model 160 performs one or more message passing steps to update the vector representation for user/event node 210F. The one or more message passing steps may be similar or the same as the message passing process described in FIG. 3. After generating an updated vector representation for user/event node 210F, in various embodiments, the updated embedding is passed through a classification model (a neural network) to generate a classification 190 for user/event node 210F. Classification 190 may be any classification or prediction that trained ML model 160 is trained to produce. In some embodiments, user/event node 210F may be classified based on its position in an embedding space. For example, an event may be classified as fraud if its respective embedding (derived after applying trained ML model 160) is located within a particular threshold of a point or area representing fraud.

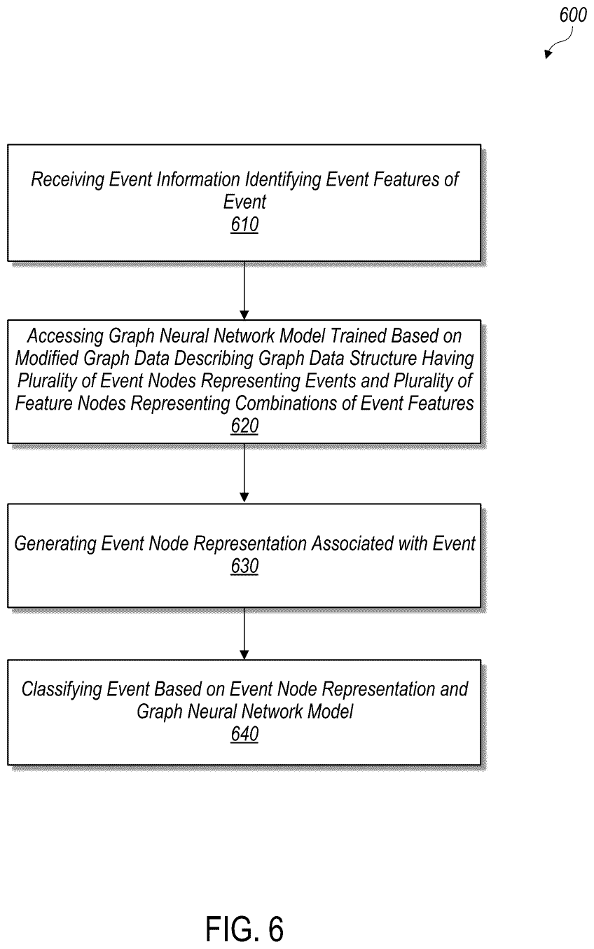

Turning now to FIG. 6, a flow diagram of a method 600 is shown. Method 600 is one embodiment of a method performed by a computer system (e.g., system 100) to classify an event (e.g., a user account sign-up) using a graph neural network model (e.g., trained ML model 160). Method 600 may be performed by executing a set of program instructions stored on a non-transitory computer-readable medium. Method 600 may include more or less steps than shown. For example, method 600 may include a step in which the graph neural network model is trained based on enhanced graph data (e.g., enhanced graph data 140).

Method 600 begins in step 610 with the computer system receiving event information identifying event features of the event. In step 620, the computer system accesses the graph neural network model trained based on modified graph data describing a graph data structure having a plurality of event nodes (e.g., user/event node 210) representing events and a plurality of feature nodes (e.g., feature nodes 230) representing combinations of event features (e.g., features 232). In various embodiments, the graph data structure includes a first group of nodes having a first set of event nodes (e.g., user/event nodes 210A-C) connected to a first feature node (e.g., feature node 230A) and a second group of nodes having a second set of event nodes (e.g., user/event nodes 210D and 210E) connected to a second feature node (e.g., feature node 230B). In various embodiments, the first group is connected to the second group via a virtual linking node (e.g., a virtual linking node 250) that enables the first set of event nodes to influence the second set of event nodes during a training phase in which the graph neural network model is trained based on the modified graph data.

In some embodiments, the plurality of event nodes and the plurality of feature nodes form a hierarchical structure having a plurality of levels (e.g., levels 410). The virtual linking node may be in a higher level of the hierarchical structure than the first and second feature nodes. The nodes located in a higher level of the hierarchical structure may be associated with a greater number of features than nodes located in a lower level of the hierarchical structure, and the weight matrices associated with the higher level may be larger than weight matrices associated with the lower level. In various embodiments, the plurality of event nodes includes a first event node connected to a particular feature node via a first edge (e.g., an edge 220) and a second event node connected to a different feature node via a second edge. The first event node may be in a lower level of the hierarchical structure than the second event node. In various embodiments, the first edge is associated with a first weight matrix (e.g., user edge weight matrix 420) of the graph neural network model and the second edge is associated with a second weight matrix that includes weights of the first weight matrix corresponding to event features of the first event node and one or more additional weights corresponding to at least one event feature of the second event node that is not included in the event features of the first event node.

In various embodiments, the plurality of event nodes includes a first event node that is connected to a particular feature node via a first edge. The particular feature node may be connected to a different feature node via a second edge and a second event node connected to the different feature node via a third edge. The first event node may be in a lower level of the hierarchical structure than the second event node. The first edge may be associated with a first weight matrix of the graph neural network model, the second edge is associated with a second weight matrix, and the third edge is associated with a third weight matrix that equals a result of a computation operation of the first and second weight matrices.

In various embodiments, the computer system accesses initial graph data (e.g., graph data 110) describing the graph data structure as having the plurality of event nodes and the plurality of feature nodes without the virtual linking node that connects the first group of nodes to the second group of nodes. In various embodiments, the computer system modifies the initial graph data to generate the modified graph data, including inserting, into the graph data structure, the virtual linking node to connect the first group of nodes to the second group of nodes. In various embodiments, the computer system trains the graph neural network model based on the modified graph data. The computer receives, from a user, a request (e.g., user input 120) to insert the virtual linking node into the graph data structure and thus the modifying may be performed in response to the user's request. The virtual linking node may represent a combination of all event features that are represented by the first feature node and the second feature node.

In step 630, the computer system generates an event node representation (e.g., a vector embedding for user/event node 210F) associated with the event. In various embodiments, the event is associated with the second group based on the event features of the event corresponding to a combination of event features represented by the second feature node. In step 640, the computer system classifies (e.g., classification 190) the event based on the event node representation and the graph neural network model. For example, event may correspond to a user account sign-up and the classification may indicate whether the sign-up is associated with a nefarious user. As another example, the event may be a transaction and the classification may indicate whether the transaction is fraudulent.

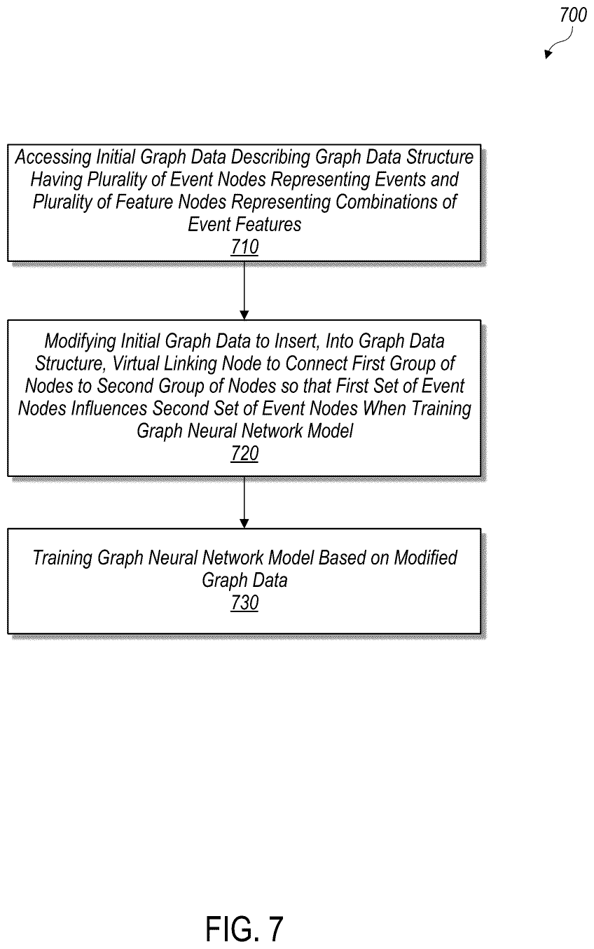

Turning now to FIG. 7, a flow diagram of a method 700 is shown. Method 700 is one embodiment of a method performed by a computer system (e.g., system 100) to train a graph neural network (e.g., ML model 152). Method 700 may be performed by executing a set of program instructions stored on a non-transitory computer-readable medium. Method 700 may include more or less steps than shown. For example, method 700 may include a step in which the graph neural network model is used in generating a classification on a new node as part of an enforcement/inference phase.

Method 700 begins in step 710 with the computer system accessing initial graph data (e.g., graph data 110) describing a graph data structure having a plurality of event nodes (e.g., user/event nodes 210) representing events and a plurality of feature nodes (e.g., feature nodes 230) representing combinations of event features. The graph data structure may include a first group of nodes having a first set of event nodes connected to a first feature node and a second group of nodes having a second set of event nodes connected to a second feature node. When training a graph neural network model based on the initial graph data, the first set of event nodes does not influence the second set of event nodes.

In step 720, the computer system modifies the initial graph data to insert, into the graph data structure, a virtual linking node (e.g., a virtual linking node 250) to connect the first group of nodes to the second group of nodes so that the first set of event nodes influences the second set of event nodes when training the graph neural network model. In various embodiments, the computer system determines to insert the virtual linking node based on a detection that an overlap between a combination of event features represented by the first feature node and a combination of event features represented by the second feature node satisfies a similarity threshold. In various embodiments, the virtual linking node represents a combination of only those event features that overlap between a combination of event features represented by the first feature node and a combination of event features represented by the second feature node.

In step 730, the computer system trains the graph neural network model based on the modified graph data (e.g., enhanced graph data 140). In various embodiments, the computer system performs a set of message passing operations in which messages associated with the first set of event nodes are passed to the second set of event nodes via the first feature node, the second feature node, and the virtual linking node. The plurality of event nodes may include a first event node connected to a first edge (e.g. an edge 220) and a second event node connected to a second edge. The second event node may be in a different level (e.g., levels 410) of a hierarchical structure than the first event node. The first edge may be associated with a first weight matrix (e.g., a user edge weight matrix 420) of the graph neural network model. In various embodiments, the computer system derives a second weight matrix associated with the second edge such that the second weight matrix includes weights of the first weight matrix corresponding to event features of the first event node and one or more additional weights corresponding to at least one event feature of the second event node that is not included in the event features of the first event node.

In various embodiments, the plurality of event nodes includes a first event node connected to a particular feature node via a first edge and a second event node connected to a different feature node via a second edge. The particular feature node and the different feature node may be connected via a third edge. In various embodiments, the computer system derives a weight matrix (e.g., a feature edge weight matrix 430) associated with the third edge such that a result of a computation operation involving the weight matrix associated with the third edge and a weight matrix associated with the first edge corresponds to a weight matrix associated with the second edge. In various embodiments, the computer system generates a plurality of embeddings for the plurality of event nodes. A given one of the plurality of embeddings may correspond to a respective one of the plurality of event nodes and is a vector representation of a set of event features (e.g., features 232) of an event corresponding to the respective event node. The graph neural network model may be trained using the plurality of embeddings.

In various embodiments, the computer system receives event information (e.g., new node data 170) identifying event features of an event. The computer system may generate an event node representation of the event based on the event features of the event and classify (e.g., generate a classification 190) the event based on the event node representation and the trained graph neural network model (e.g., trained ML model 160).

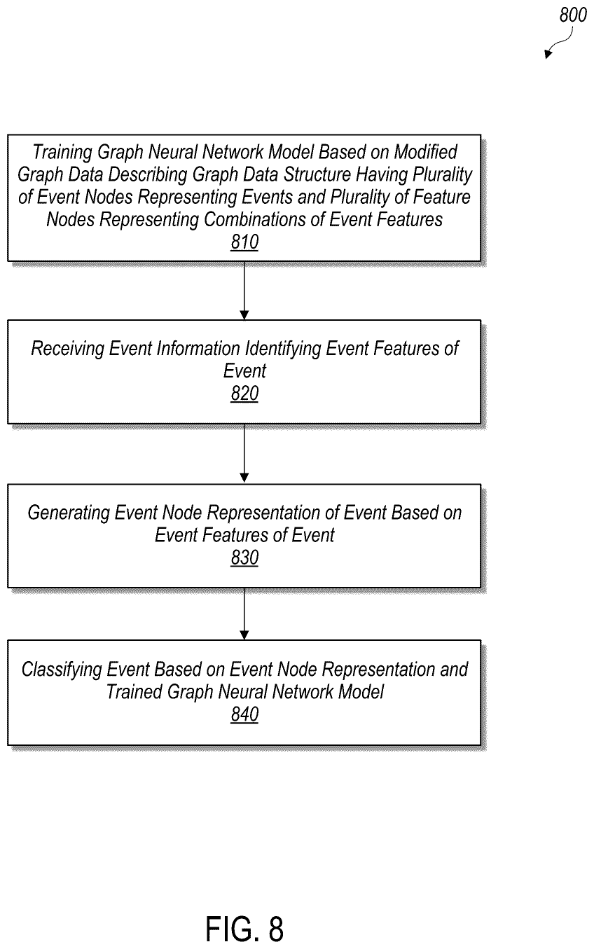

Turning now to FIG. 8, a flow diagram of a method 800 is shown. Method 800 is one embodiment of a method performed by a computer system (e.g., system 100) to classify an event (e.g., a user/event node 210) using a trained graph neural network model (e.g., trained ML model 160). Method 800 may be performed by executing a set of program instructions stored on a non-transitory computer-readable medium. Method 800 may include more or less steps than shown.

Method 800 begins in step 810 with the computer system training a graph neural network model (e.g., ML model 152) based on modified graph data (e.g., enhanced graph data 140) describing a graph data structure having a plurality of event nodes representing events and a plurality of feature nodes (e.g., feature nodes a230) representing combinations of event features. The graph data structure may include a first group of nodes having a first set of event nodes connected to a first feature node and a second group of nodes having a second set of event nodes connected to a second feature node. The first group may be connected to the second group via a virtual linking node (e.g., a virtual linking node 250) that enables the first set of event nodes to influence the second set of event nodes during the training.

In various embodiments, the computer system accesses initial graph data (e.g., graph data 110) describing the graph data structure as having the plurality of event nodes and the plurality of feature nodes without the virtual linking node that connects the first group of nodes to the second group of nodes. In various embodiments, the computer system receives, from a user, a request (e.g., user input 120) to insert the virtual linking node into the graph data structure. In various embodiments, the computer system modifies the initial graph data to generate the modified graph data, including inserting, into the graph data structure, the virtual linking node to connect the first group of nodes to the second group of nodes.

In various embodiments, the plurality of event nodes includes a first event node connected to a particular feature node via a first edge (e.g., an edge 220) and a second event node connected to a different feature node via a second edge. The particular feature node and the different feature node may be connected via a third edge. The first edge may be associated with a first weight matrix (e.g., a user edge weight matrix 420) of the graph neural network model. In various embodiments, the computer system derives a second weight matrix associated with the second edge such that the second weight matrix includes weights of the first weight matrix corresponding to event features of the first event node and one or more additional weights corresponding to at least one event feature of the second event node that is not included in the event features of the first event node. In various embodiments, the computer system derives a third weight matrix (e.g., a feature edge weight matrix 430) associated with the third edge such that the second weight matrix is a result of a computation operation involving the third weight matrix and the first weight matrix.

In step 820, the computer system receives event information (e.g., new node data 170) identifying event features of an event. In step 830, the computer system generates an event node representation of the event based on the event features of the event. The event may be associated with the second group based on the event features of the event corresponding to a combination of event features represented by the second feature node. The event node representation of the event may be a vector representation of the event features of the event. In step 840, the computer system classifies (e.g., generates a classification 190) the event based on the event node representation and the trained graph neural network model.

### Exemplary Computer System

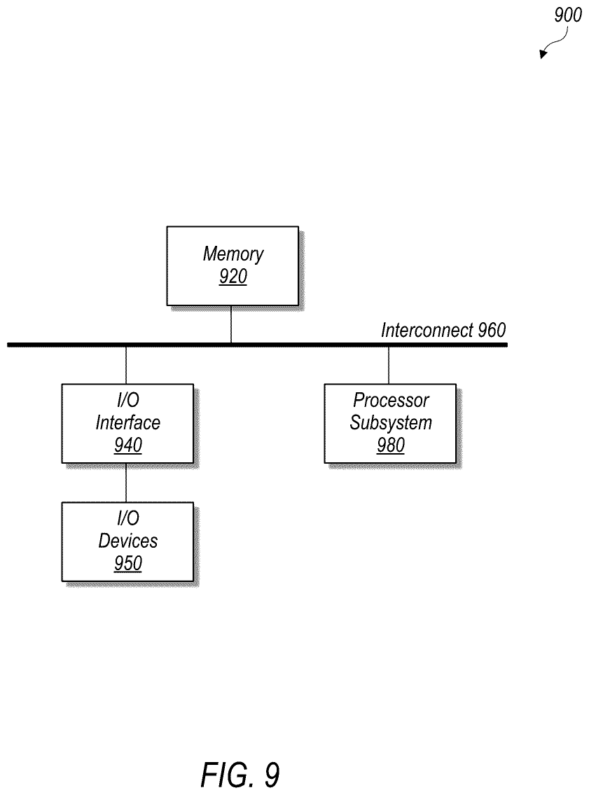

Turning now to FIG. 9, a block diagram of an exemplary computer system 900, which may implement system 100, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In some embodiments, program instructions that when executed implement virtual node module 130, training module 150, and/or enforcement module 180 may be included/stored within system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method for classifying an event, the method comprising:
receiving, by a computer system, event information identifying event features of the event;
accessing, by the computer system, a graph neural network model trained based on modified graph data describing a graph data structure having a plurality of event nodes representing events and a plurality of feature nodes representing combinations of event features, wherein the graph data structure includes a first group of nodes having a first set of event nodes connected to a first feature node and a second group of nodes having a second set of event nodes connected to a second feature node, wherein the first group is connected to the second group via a virtual linking node that enables the first set of event nodes to influence the second set of event nodes during a training phase in which the graph neural network model is trained based on the modified graph data;
generating, by the computer system, an event node representation associated with the event, wherein the event is associated with the second group based on the event features of the event corresponding to a combination of event features represented by the second feature node; and
classifying, by the computer system, the event based on the event node representation and the graph neural network model.

2. The method of claim 1, wherein the plurality of event nodes and the plurality of feature nodes form a hierarchical structure having a plurality of levels, and wherein the virtual linking node is in a higher level of the hierarchical structure than the first and second feature nodes.

3. The method of claim 2, wherein nodes located in a higher level of the hierarchical structure are associated with a greater number of features than nodes located in a lower level of the hierarchical structure, and wherein weight matrices associated with the higher level are larger than weight matrices associated with the lower level.

4. The method of claim 2, wherein the plurality of event nodes includes:
a first event node connected to a particular feature node via a first edge; and
a second event node connected to a different feature node via a second edge, wherein the first event node is in a lower level of the hierarchical structure than the second event node; and
wherein the first edge is associated with a first weight matrix of the graph neural network model and the second edge is associated with a second weight matrix that includes weights of the first weight matrix corresponding to event features of the first event node and one or more additional weights corresponding to at least one event feature of the second event node that is not included in the event features of the first event node.

5. The method of claim 2, wherein the plurality of event nodes includes:
a first event node connected to a particular feature node via a first edge, wherein the particular feature node is connected to a different feature node via a second edge; and
a second event node connected to the different feature node via a third edge, wherein the first event node is in a lower level of the hierarchical structure than the second event node; and
wherein the first edge is associated with a first weight matrix of the graph neural network model, the second edge is associated with a second weight matrix, and the third edge is associated with a third weight matrix that equals a result of a computation operation of the first and second weight matrices.

6. The method of claim 1, further comprising:
accessing, by the computer system, initial graph data describing the graph data structure as having the plurality of event nodes and the plurality of feature nodes without the virtual linking node that connects the first group of nodes to the second group of nodes;
modifying, by the computer system, the initial graph data to generate the modified graph data, including inserting, into the graph data structure, the virtual linking node to connect the first group of nodes to the second group of nodes; and
training, by the computer system, the graph neural network model based on the modified graph data.

7. The method of claim 6, further comprising:
receiving, by the computer system from a user, a request to insert the virtual linking node into the graph data structure, wherein the modifying is performed in response to the request.

8. The method of claim 1, wherein the virtual linking node represents a combination of all event features that are represented by the first feature node and the second feature node.

9. A non-transitory computer-readable medium having program instructions stored thereon that are capable of causing a computer system to perform operations comprising:
accessing initial graph data describing a graph data structure having a plurality of event nodes representing events and a plurality of feature nodes representing combinations of event features, wherein the graph data structure includes a first group of nodes having a first set of event nodes connected to a first feature node and a second group of nodes having a second set of event nodes connected to a second feature node, wherein, when training a graph neural network model based on the initial graph data, the first set of event nodes does not influence the second set of event nodes;
modifying the initial graph data to insert, into the graph data structure, a virtual linking node to connect the first group of nodes to the second group of nodes so that the first set of event nodes influences the second set of event nodes when training the graph neural network model; and
training, by the computer system, the graph neural network model based on the modified graph data.

10. The non-transitory computer-readable medium of claim 9, wherein the training includes:
performing a set of message passing operations in which messages associated with the first set of event nodes are passed to the second set of event nodes via the first feature node, the second feature node, and the virtual linking node.

11. The non-transitory computer-readable medium of claim 9, wherein the plurality of event nodes includes a first event node connected to a first edge and a second event node connected to a second edge, wherein the second event node is in a different level of a hierarchical structure than the first event node, wherein the first edge is associated with a first weight matrix of the graph neural network model, and wherein the training includes:
deriving a second weight matrix associated with the second edge such that the second weight matrix includes weights of the first weight matrix corresponding to event features of the first event node and one or more additional weights corresponding to at least one event feature of the second event node that is not included in the event features of the first event node.

12. The non-transitory computer-readable medium of claim 9, wherein the plurality of event nodes includes a first event node connected to a particular feature node via a first edge and a second event node connected to a different feature node via a second edge, wherein the particular feature node and the different feature node are connected via a third edge, and wherein the training includes:
deriving a weight matrix associated with the third edge such that a result of a computation operation involving the weight matrix associated with the third edge and a weight matrix associated with the first edge corresponds to a weight matrix associated with the second edge.

13. The non-transitory computer-readable medium of claim 9, wherein the operations further comprise:
determining to insert the virtual linking node based on a detection that an overlap between a combination of event features represented by the first feature node and a combination of event features represented by the second feature node satisfies a similarity threshold.

14. The non-transitory computer-readable medium of claim 9, wherein the operations further comprise:
receiving event information identifying event features of an event;
generating an event node representation of the event based on the event features of the event; and
classifying the event based on the event node representation and the trained graph neural network model.

15. The non-transitory computer-readable medium of claim 9, wherein the virtual linking node represents a combination of only those event features that overlap between a combination of event features represented by the first feature node and a combination of event features represented by the second feature node.

16. The non-transitory computer-readable medium of claim 9, wherein the operations further comprise:
generating a plurality of embeddings for the plurality of event nodes, wherein a given one of the plurality of embeddings corresponds to a respective one of the plurality of event nodes and is a vector representation of a set of event features of an event corresponding to the respective event node, and wherein the graph neural network model is trained using the plurality of embeddings.

17. A non-transitory computer-readable medium having program instructions stored thereon that are capable of causing a computer system to perform operations comprising:
training a graph neural network model based on modified graph data describing a graph data structure having a plurality of event nodes representing events and a plurality of feature nodes representing combinations of event features, wherein the graph data structure includes a first group of nodes having a first set of event nodes connected to a first feature node and a second group of nodes having a second set of event nodes connected to a second feature node, wherein the first group is connected to the second group via a virtual linking node that enables the first set of event nodes to influence the second set of event nodes during the training;
receiving event information identifying event features of an event;
generating an event node representation of the event based on the event features of the event, wherein the event is associated with the second group based on the event features of the event corresponding to a combination of event features represented by the second feature node; and
classifying the event based on the event node representation and the trained graph neural network model.

18. The non-transitory computer-readable medium of claim 17, wherein the operations further comprise:
accessing initial graph data describing the graph data structure as having the plurality of event nodes and the plurality of feature nodes without the virtual linking node that connects the first group of nodes to the second group of nodes;
receiving, from a user, a request to insert the virtual linking node into the graph data structure; and
modifying, by the computer system, the initial graph data to generate the modified graph data, including inserting, into the graph data structure, the virtual linking node to connect the first group of nodes to the second group of nodes.

19. The non-transitory computer-readable medium of claim 17, wherein the plurality of event nodes includes a first event node connected to a particular feature node via a first edge and a second event node connected to a different feature node via a second edge, wherein the particular feature node and the different feature node are connected via a third edge, wherein the first edge is associated with a first weight matrix of the graph neural network model, and wherein the training includes:
deriving a second weight matrix associated with the second edge such that the second weight matrix includes weights of the first weight matrix corresponding to event features of the first event node and one or more additional weights corresponding to at least one event feature of the second event node that is not included in the event features of the first event node; and
deriving a third weight matrix associated with the third edge such that the second weight matrix is a result of a computation operation involving the third weight matrix and the first weight matrix.

20. The non-transitory computer-readable medium of claim 17, wherein the event node representation of the event is a vector representation of the event features of the event.
